(19) United States
(12) Patent Application Publication
(10) Pub. No.: US 2026/0352503 A1
(43) Pub. Date: Nov. 5, 2026

(54) Method for Wirelessly Registering a Pump Having a Pump Control With a Central Administration Unit Using a Mobile Communication Device

(71) Applicant: KSB SE & Co. KGaA, Frankenthal (DE)

(72) Inventors: Daniel GONTERMANN, Frankenthal (DE); Patrick HAUCK, Frankenthal (DE); Sebastian MEISINGER, Frankenthal (DE); Benedikt MÜLLER, Frankenthal (DE); Patrick SCHMITT, Frankenthal (DE); Christoph KOEHLER, Frankenthal (DE); Jochen SCHAAB, Frankenthal (DE)

(21) Appl. No.: 19/124,734

(22) PCT Filed: Oct. 12, 2023
(86) PCT No.: PCT/EP2023/078316

§ 371 Date: Apr. 25, 2025

(30) Foreign Application Priority Data
Oct. 28, 2022 (DE) 10 2022 128 739.4

(51) Int. Cl. H04L 12/12; H04L 67/12

(52) U.S. Cl. CPC H04L 12/12; H04L 67/12

(57) ABSTRACT

A method for wirelessly registering a pump using a mobile communication device includes the steps of transmitting, receiving, and transferring. In the step of transmitting, a broadcast signal is transmitted with a signal generator of the pump control when the pump is not yet registered with the central administration unit. The receiving step includes receiving with the mobile communication device, the broadcast signal in an activated monitoring mode. The transferring step includes transferring identification information configured to identify the pump to the central administration unit.

### CROSS REFERENCE TO RELATED APPLICATION

This application is a 371 National Stage Application of PCT/EP2023/078316, filed Oct. 12, 2023, which claims priority from German Patent Application No. 102022128739.4, filed Oct. 28, 2022, the entire disclosure of which is herein expressly incorporated by reference.

### BACKGROUND

The disclosure relates to a method for wirelessly registering a pump having a pump control with a central administration unit using a mobile communication device.

Pumps are used both in industry and in private households, for example In heating and service water systems. In order to optimize the service provided, pump manufacturers have an interest in registering the pumps that they have delivered and commissioned. This allows the pumps to be better monitored during operation and, if required, the manufacturer can offer customer-specific service and maintenance services.

### SUMMARY

Until now, the customer has been registered via the pump manufacturer's website. The customer receives an invitation or request for registration in the operating instructions of the supplied pump or through other information attached to the pump or the packaging of the pump. In practice, however, the rate of successful registrations could be improved, since the associated effort obviously still prevents the customer from doing so. It is therefore desirable to specify an improved method that will better remind the customer of the registration process or make the entire registration process easier.

This and other objects are achieved by a method according to the features of this disclosure. Advantageous embodiments of the method are also the subject matter of this disclosure.

According to the disclosure it is proposed that a signal generator of the pump control transmits a form of broadcast signal if the pump has not yet been registered with a central administration unit. A mobile communication device, which is in an activated monitoring mode, can automatically receive the broadcast signal and transmit identification information that uniquely identifies the pump to the central administration unit.

The mobile communication device can be, for example, a commercially available smartphone, a tablet or a laptop with a dedicated application installed. Alternatively, the communication device can also be a special service device from the pump manufacturer. If the customer or a service engineer enters the reception range around the pump with the communication device and the application installed and executed thereon, the communication device can receive the broadcast signal transmitted by the pump and automatically detect an unregistered pump. The communication device can then transmit identification information for identifying the pump to a central administration unit, either automatically or after user input has been made.

It is conceivable, for example, that the broadcast signal is transmitted continuously by the pump controller, provided that the pump itself considers itself to be “not registered”. In this context, it makes sense if the transmission technology or the chosen signal type of the broadcast signal is not perceived as disturbing to people. Potential interference with nearby electronic equipment should also be avoided as far as possible.

The broadcast signal must not be able to be detected by human beings without technical aids. It is also conceivable to use a type of signal that is perceptible by humans, but only to a tolerable extent, so that the broadcast signal is not perceived by the person as consistently disturbing. This has the advantage that the user is reminded of the registration even without a communication device when the user moves close to the pump.

It is also conceivable that the broadcast signal is only transmitted for a defined period of time and, if registration is not completed after a defined transmission period, the broadcast signal is deactivated. It is also conceivable to transmit the broadcast signal repeatedly at periodic intervals.

The aforementioned identification information can advantageously already be contained in the broadcast signal, i.e. the information does not need to be generated by the communication device, but instead originates directly from the pump itself. The mobile communication device can communicate the identification information to the central administration unit after receiving and evaluating the broadcast signal.

The central administration unit can be a central server system of the pump manufacturer or of a third-party company. A cloud-based solution is also conceivable. The central administration unit is used in particular to manage and identify the delivered pumps and to optionally assign the identified pumps to customer data. Based on this information, the manufacturer can offer targeted service information or services. It is also conceivable to use such an administration unit as a fleet management tool, i.e. for centrally monitoring the registered pumps running in the field. For this purpose, it is desirable that the pump transmits further operating data while it is running.

In general, the use of a broadcast signal has the advantage that there is no need to establish a communication channel between the mobile communication device and the pump. The user only needs to activate the communication device for receiving the broadcast signal, in particular by launching a dedicated application that puts the communication device into the receive mode. Since the chosen transmission technology does not require direct visual contact between the pump and the communication device, the method manifests its advantages in particular in the case of pumps that are difficult to access, for example, hidden and/or even installed inside other devices and systems. A further advantage of the method comes into play when a large number of pumps are installed at the installation site, the detection of which can then be performed automatically by the communication device.

In general, the transmission technology for the broadcast signal can be freely chosen, but the most advantageous type is a radio transmission technology which in particular does not require direct visual contact, which is advantageous due to the often poorly accessible installation position. According to the preferred embodiment, the technology chosen is to use an acoustic signal for transmitting the broadcast signal. In this case, the already installed microphone of a communication device, such as a conventional smartphone or tablet, can be used for receiving the acoustic signal. The acoustic signal may be in frequency ranges that are not perceptible to humans. However, it is also conceivable to use audible frequency ranges, provided that the generated acoustic signal is not perceived as disturbing to humans.

It is particularly preferred if the acoustic broadcast signal is generated by an existing component of the pump control, i.e. no separate communication module needs to be installed, but instead an existing component can be used for the transmission of the broadcast signal. Preferably, the motor control, in particular a built-in frequency converter, can be used for generating the acoustic signal. Normal operating noises of the pump can be modulated with additional information, which is detected by appropriate signal evaluation by the communication device.

According to an advantageous embodiment, for example, the output voltage generated by the frequency converter, i.e. the motor supply voltage, is changed, thereby generating a detectable acoustic signal. For normal operation of the pump motor, the motor voltage is generated with variable fundamental frequency and amplitude at the output of the frequency converter. Preferably, this voltage can be modulated by, for example, a voltage waveform with a higher frequency than the fundamental frequency, i.e. a so-called high-voltage injection can be performed by suitable activation of the frequency converter. By means of a suitable injection of a high-frequency voltage waveform onto the fundamental-frequency motor voltage, a definable acoustic signal can be generated while the pump is in operation, which can be detected by the communication device. This additional frequency modulation of the motor voltage does not affect, or only marginally affects, the normal pump operation so that the pump continues to function properly.

Instead of the option of high-frequency injection, in an advantageous embodiment of the disclosure it is proposed to modify the switching frequency with which the integral switching elements of the inverter component of the frequency converter are switched. The modification of the switching frequency does not normally affect the output voltage generated, but results in a different acoustic operating noise of the pump.

It is conceivable, for example, that the switching elements are initially switched with a typically constant reference switching frequency. If information transfer from the pump to the communication device is occurring, the switching frequency is preferably increased or reduced by a defined amount. This deviation of the current switching frequency from an original reference switching frequency can be detected acoustically and thus detected by the communication device. For example, at an original reference switching frequency of 16kHz, the pump could be signaled as unregistered in relation to the communication device by reducing the switching frequency to 15kHz.

According to a preferred extension of the disclosure the defined change in the switching frequency can also be used to transfer a binary data sequence from the pump to the communication device. For this purpose, the change in the switching frequency must be controlled by a timer, i.e. the change in the switching frequency must take place at defined times. If the communication device is synchronized with the temporal rate of change, a binary data sequence can be transferred from the pump to the communication device.

Instead of an acoustic signal, an ultrasonic signal can also be used to transmit the broadcast signal.

After receiving the identification information from the mobile communication device the central administration unit can generate registration information and transmit this back to the mobile communication device. The latter can then be configured to forward the received registration information to the pump control or the pump. In this case, after receiving the registration information, the registration process can be successfully completed and the pump is deemed to be registered. The pump also stops transmitting the broadcast signal.

For example, the same transmission technology can be used to transfer the registration information to the pump controller as that used to transfer the broadcast signal. However, it is conceivable and advantageous instead to set up a separate communication channel with a different transmission technology between the pump and the communication device. It is conceivable here to use known transmission standards such as Bluetooth, in particular low-power Bluetooth. In this way, more detailed information can be exchanged between the pump and the communication device, such as information about the pump condition, which allows external monitoring and, if necessary, diagnosis by the administration unit.

For example, the establishment of a separate transmission channel can be triggered manually by the user of the communication device or of the pump. It is also conceivable that the establishment of the communication channel is initiated automatically by the application executed on the communication device, in particular after receipt of the registration information from the administration unit. A connection set up in this way between the pump and the communication device can then be used for transmitting the received registration information to the pump control.

It is particularly advantageous if the pump, after receiving the registration information, either stops the transmission of the broadcast signal completely or alternatively modifies the transmitted broadcast signal. By modifying the broadcast signal, follow-up information could then be transmitted, for example, to indicate successful registration. The communication device can thus distinguish all registered pumps in the receiving range from unregistered pumps by evaluating the broadcast signals.

However, the broadcast signal of the pump can be used not only to display the registration status and identify the pump, but also to conceal more detailed information within the broadcast signal. It is also conceivable, for example, to transmit a kind of status indicator within the broadcast signal, which can be used to indicate the functional readiness or an anomaly of the pump. Based on the received broadcast signal, the communication device can then distinguish functional pumps from pumps exhibiting anomalies.

For example, after receiving a broadcast signal which identifies an anomaly of the pump, it is conceivable that the communication device requests further information from the pump control via the transmission technology of the broadcast signal or via the separate communication channel, in order to then pass this additional diagnostic information on to the central administration unit.

For the registration process, it may be desirable that, after receiving the identification information, the application executed on the communication device first generates a user query before the registration process is continued or even completed. By using such a query, the user of the communication device can be prompted to enter customer-specific data. Once the data has been entered, the application then forwards the data, in particular together with the identification information, to the central administration unit.

In addition to the method according to the disclosure, the present disclosure relates to a system comprising at least one pump, at least one mobile communication device and at least one central administration unit. The system is configured according to the disclosure in such a way that the steps specified by the method according to the disclosure are carried out. In particular, the pump of the system provides a signal generator or an adapted motor control to enable the generation and transmission of a suitable broadcast signal for the transmission of identification information as well as possible status information. The communication device used is suitable for receiving and evaluating such a broadcast signal. A separate communication channel for the exchange of diagnostic information can also be established between the communication device and the pump control. Furthermore, the communication device can communicate with a central administration unit via a further transmission standard.

In addition to the system according to the disclosure, the present disclosure also relates to a pump, preferably a centrifugal pump, particularly preferably a heating circulation pump having a pump control, which is configured for carrying out the method according to the disclosure. Finally, the disclosure also relates to a computer program comprising commands which, when the program is executed by a mobile communication device, cause it to carry out the method or steps of the method according to the present disclosure. In particular, the computer program puts the communication device into a monitoring state for receiving and evaluating the broadcast signal using the integrated receiving module, in particular the integral microphone of the device.

Further advantages and properties of the disclosure are explained in more detail in the following by means of the application steps illustrated in the figures. In the figures:

### BRIEF DESCRIPTION OF THE DRAWINGS

FIG. 1: shows a schematic sketch of the method steps according to a first application scenario; and

FIG. 2: shows a sketch of the schematic steps during a second application scenario.

### DETAILED DESCRIPTION

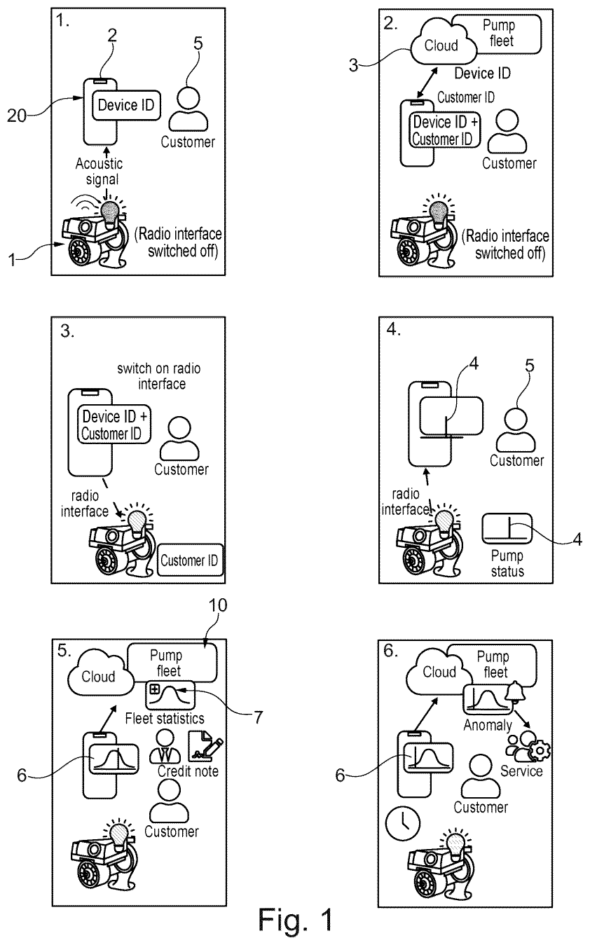

FIG. 1 schematically sketches the method steps of the disclosure. The pump 1 shown here is a heating circulation pump that is installed in the heating system of the customer 5. The heating circulation pump 1 comprises an electric motor, which is energy-efficiently controlled by means of an integrated frequency converter. According to the method according to the disclosure, an acoustic signal 20 is generated by the frequency converter of the pump 1 for signaling status information. The status information, hereinafter referred to as “acoustic red or green lamp”, indicates whether or not the pump 1 has been registered with the pump manufacturer 3. The individual steps of the registration process are shown chronologically in the six illustrations of FIG. 1.

### Step 1

In the delivery state of the pump 1, this transmits an acoustic signal 20 (“acoustic red lamp”), which can be detected via the microphone of a smartphone 2 and which contains a DeviceID of the pump 1. The acoustic signal 20 is generated by means of the method according to the disclosure by variation of an operating parameter of the installed frequency converter of the pump 1.

In addition to the voltage waveform at a fundamental frequency required for the motor operation, here the option exists of having an additional high-frequency voltage waveform generated by the frequency converter by means of a so-called high-frequency injection. This high-frequency voltage waveform can be injected in such a way that an acoustic signal 20 is produced, which can be detected by the smartphone 2 and evaluated by the application installed thereon. In particular, the application performs a real-time FFT analysis of the signal previously recorded via the microphone of the smartphone.

Alternatively, an acoustically detectable or perceptible signal 20 could be generated by varying the switching frequency of the frequency converter, so that the deviation from a fixed reference frequency can be used to transmit information. At a reference switching frequency of 16 kHz, for example, a switching frequency of 15kHz could signal that the pump 1 is not registered (“acoustic red lamp”). The fundamental frequency for the actual operation of the motor is usually in the range 50 Hz to 300 Hz and is not affected by the variation of the switching frequency. If a fixed time window is set for the variation between two or even more switching frequencies, it is possible to send rudimentary digital information such as the DeviceID in the form of binary ‘1’ and ‘0’as a “broadcast”.

When a corresponding application is executed on the smartphone 2, the acoustic signal 20 can be evaluated and the pump 1 can be identified as an as yet unregistered pump. Furthermore, the acoustic signal 20 may already contain the DeviceID of the pump 1, which the smartphone 2 receives and can use in further stages of the process.

### Step 2

After reception of the DeviceID of the pump 1 by the smartphone 2, the user 5 is directed via the app of the smartphone 2 to an online registration of the pump 1. The connection between smartphone 2 and cloud 3 can be at least partially implemented by a mobile phone standard, e.g. LTE, or WLAN. The DeviceID is transferred to a cloud service 3 of the pump manufacturer where it is linked to a CustomerID.

### Step 3

Once the CustomerID has been provided and linked to the DeviceID, the CustomerID is subsequently imported into the pump 1 via an optional additional digital communication link between the smartphone 2 and pump 1 in accordance with the Bluetooth/Bluetooth Low Energy Standard. The generated acoustic signal 20 of the pump 1 changes to the “acoustic green lamp”, e.g. by undoing the variation of the operational parameter. However, the transfer of the CustomerID to the pump 1 is only optional; alternatively, a manual entry on the pump control panel could also be used to indicate to the pump 1 that the registration was successful.

### Step 4

The registered pump 1 sends an identifier of its health value 4 to the app of the smartphone 2, either also via the acoustic signal 20 or preferably via the established Bluetooth connection.

### Step 5

This health value 4 is sent from the smartphone 2 to the cloud 3. In the cloud 3, a comparison of the transferred health value 4 of the pump 1 with the health values 7 of an anonymous fleet 10 of comparable pump models is made. The customer 5 then receives an assessment 6 of their own pump 1 in comparison to the anonymous fleet 10.

### Step 6

In the event of a malfunction or an anomaly, the acoustic signal 20 is used again to alert the customer 5 to the anomaly of the pump 1. The acoustic “green lamp flashes” to signal an anomaly. The service team 11 can then actively approach the customer 5 with a known CustomerID and offer servicing for the pump 1.

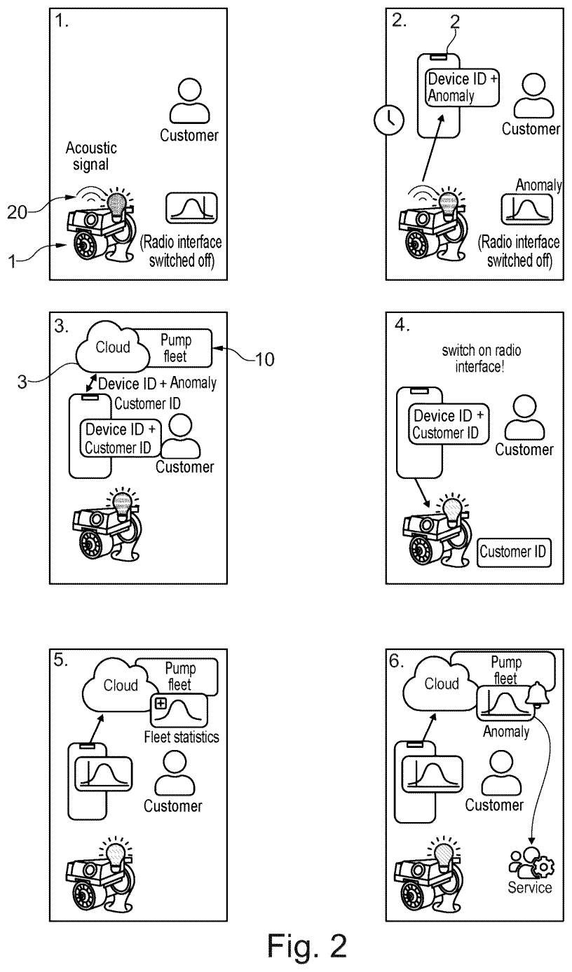

FIG. 2 shows a modified application scenario for the method according to the disclosure. In contrast to the first scenario according to FIG. 1, in the use case according to FIG. 2 a malfunction has already occurred in a pump that has not yet been registered (“red lamp”). The pump 1 is able to detect the anomaly automatically even without a connection to the cloud 3. After the anomaly has been detected by the pump 1, the acoustic signal is used to draw the customer's attention to pump 1. If the acoustic signal is detected by the smartphone 2, the registration process should also be carried out here in order to link the unique DeviceID of the pump 1 to a CustomerID and thus be able to offer customer-specific services.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-17. (canceled)

18. A method for wirelessly registering a pump having a pump control with a central administration unit using a mobile communication device, comprising:
transmitting a broadcast signal with a signal generator of the pump control when the pump is not yet registered with the central administration unit;
receiving with the mobile communication device, the broadcast signal in an activated monitoring mode; and
transferring identification information configured to identify the pump to the central administration unit.

19. The method as claimed in claim 18, wherein the pump control transmits the broadcast signal continuously when the pump has not yet been registered.

20. The method as claimed in claim 19, wherein the broadcast signal contains at least one information item that uniquely identifies the pump and the mobile communication device communicates said information to the central administration unit after receiving the broadcast signal.

21. The method as claimed in claim 20, wherein the broadcast signal is an acoustic signal, which is generated by the motor controller via modified actuation of the pump drive.

22. The method as claimed in claim 21, wherein the acoustic signal is a normal operating noise of the pump, which has been modulated with information by the motor controller.

23. The method as claimed in claim 18, wherein the broadcasting signal is an ultrasound signal.

24. The method as claimed in claim 23, wherein the central administration unit, after receiving the identification information, transfers registration information to the mobile communication device for forwarding to the pump control.

25. The method as claimed in claim 24, wherein the communication device forwards the registration information to the pump control via the transmission technology used for the broadcast signal or alternatively, establishes a separate transmission channel with different transmission technology and transfers the registration information to the pump control via this separate channel.

26. The method as claimed in claim 25, wherein the separate transmission channel is a bidirectional radio channel for bidirectional information exchange between the communication device and the pump control, is compliant with Bluetooth standard.

27. The method as claimed in claim 26, wherein the pump control, after successfully receiving the registration information, deactivates the transmission of the broadcast signal or modifies the broadcast signal, wherein the modified broadcast signal contains information that identifies the pump as registered.

28. The method as claimed in claim 26, wherein the broadcast signal and/or the modified broadcast signal contains information for signaling the functional status of the pump.

29. The method as claimed in claim 28, wherein the mobile communication device is a smartphone, tablet or a mobile computer and a dedicated application implements a monitoring mode of the device.

30. The method as claimed in claim 29, wherein the application uses the built-in microphone of the device to analyze audio sequences in order to identify identification and/or status information from a received broadcast signal.

31. The method as claimed in claim 29, wherein the application, after identifying the identification information, generates a request for customer data and transfers the customer data entered by the user to the central administration unit.

32. A system comprising at least one pump, at least one mobile communication device and at least one central administration unit, wherein the system is configured to carry out the steps according to the method as claimed in claim 31.

33. A centrifugal pump, configured as a heating circulation pump, having a pump control configured to carry out the method as claimed in claim 31, for generating and transmitting the broadcast signal.

34. A computer program comprising instructions which, when executed by a mobile communication device, cause said mobile communication device to carry out the steps of the method as claimed in claim 31, to transfer the communication device into a monitoring state for receiving and evaluating a broadcast signal.
